(19) United States
(12) Patent Application Publication
(10) Pub. No.: US 2009/0149158 A1
(43) Pub. Date: Jun. 11, 2009

(54) SYNCHRONIZED VOICE AND DATA SYSTEM

(76) Inventors: David E. Goldfarb, Bet Shemesh (IL); David G.M. Jacobson, Haela (IL); Dani S. Waxman, Beit Shemesh (IL)

Correspondence Address: DANIEL J SWIRSKY, 55 REUVEN ST., BEIT SHEMESH, 99544, IL

(21) Appl. No.: 11/997,000

(22) PCT Filed: Jul. 26, 2006
(86) PCT No.: PCT/IL06/00868

§ 371 Date: Jun. 25, 2008

Related U.S. Application Data
(60) Provisional application No. 60/703,448, filed on Jul. 29, 2005.
(60) Provisional application No. 60/719,176, filed on Sep. 22, 2005.

(51) Int. Cl. H04W 4/14; H04M 3/42

(52) U.S. Cl. 455/414.1; 455/466

(57) ABSTRACT

A method includes sending data content (32) to user (12) of a mobile device during a telephone call. The content may be a web page, it may be text, video, images, audio, etc. The method may include coupling a web session with a voice session.

### FIELD OF THE INVENTION

The present invention relates generally to client-server systems, both interactive voice response (IVR) systems and data input systems.

### BACKGROUND OF THE INVENTION

Voice is a powerful medium for communication, yet few aspects of modern technology engender more dismay than the “voice hell” of Interactive Voice Response (IVR) systems. Customers are frustrated by lengthy and confusing interactions with ever-so-polite mechanical voices. Vendors lose money when customers prematurely call for a human operator and risk alienating customers who abandon the system altogether.

Today IVR systems vary from extremely simple “Press ‘1’ to leave a message or ‘0’ for the operator” through sophisticated enterprise-support systems with complex menus, voice recognition, and massive database back-ends. With proper design and good user-interface, surprising amounts of information can be conveyed via voice over IVR. But, IVR suffers from many limitations, some of which are described below.

Customers get lost in overly complex voice menus and lose patience with the droning voice reading menus. Because speech is a linear and transient medium, vendors limit the services they offer via IVR in order to avoid confusing their customers. Customers find it difficult to retain sufficient mental context, so vendors must expend efforts balancing verbosity against obscurity. Customers have difficulty retracing their steps to services they previously found. Finally, speech recognition allows the customer to bombard the IVR system with arbitrary input. When the IVR system fails to respond appropriately to unexpected input, users lose confidence in the entire system.

### SUMMARY OF THE PRESENT INVENTION

It is an object of the present invention to solve some of the problems in the prior art.

There is therefore provided, in accordance with a preferred embodiment of the present invention, a synchronized voice and data system. The system includes a synchronizer to create a real-time synchronous link between a phone call and an associated web session.

Additionally, in accordance with a preferred embodiment of the present invention, the web session has image, video and/or advertising content therein.

Moreover, in accordance with a preferred embodiment of the present invention, the phone call is a mobile phone call and the web session is a web session from the mobile device. Alternatively, the web session can be a computer web session.

Further, in accordance with a preferred embodiment of the present invention, the phone call includes an IVR (interactive voice response) session coupled to an IVR script server.

Still further, in accordance with a preferred embodiment of the present invention, the synchronizer includes a state maintainer to trigger at least one action in the IVR session in response to an action by a user in the web session. The state maintainer also can trigger at least one action in a web session in response to an action by a user in an IVR session.

Additionally, in accordance with a preferred embodiment of the present invention, the phone call includes a voice session with at least one live operator. The synchronizer includes a state maintainer to inform the at least one live operator regarding any action performed by a user during the web session.

There is also provided, in accordance with a preferred embodiment of the present invention, a method including coupling a web or data session with a voice session.

Additionally, in accordance with a preferred embodiment of the present invention, the coupling includes sending a URL for a synchronizable website. It can also include initiating a phone call coupled to an existing web session, or, initiating a web session coupled to an existing phone call.

Moreover, in accordance with a preferred embodiment of the present invention, the web session may have image, video and/or advertising content therein.

Further, in accordance with a preferred embodiment of the present invention, the phone call is a mobile phone call and the web session is a web session from the mobile device.

Still further, in accordance with a preferred embodiment of the present invention, the sending includes one of the following methods: via SMS and via speech.

Additionally, in accordance with a preferred embodiment of the present invention, the coupling includes sending a password or token for the synchronizable website. It can also include providing a phone number for a synchronized phone call. The phone number can be specific to the coupled sessions, or it can be a non-specific number, in which case, the providing comprises also includes providing a token to be provided after dialing the non-specific phone number.

Moreover, in accordance with a preferred embodiment of the present invention, the voice session is connectable to a cellular telephone.

There is also provided, in accordance with an alternative preferred embodiment of the present invention, a method including sending data content to a mobile device during a telephone call.

Moreover, in accordance with a preferred embodiment of the present invention, the content is a web content which may have image, video and/or advertising content therein.

Further, in accordance with a preferred embodiment of the present invention, a caller of the telephone call is waiting for a response from at least one live operator.

Still further, in accordance with a preferred embodiment of the present invention, the sending includes synchronizing between a phone call and an associated web session.

There is also provided, in accordance with a further alternative preferred embodiment of the present invention, a method including directing a caller of a phone call to a web session associated with the phone call.

There is further provided, in accordance with a further preferred embodiment of the present invention, a method including providing a visual site map of an interactive voice response (IVR) system to a caller to the IVR system.

Moreover, in accordance with a preferred embodiment of the present invention, the providing includes synchronizing between a phone call to the IVR system and an associated web session showing the site map.

Further, in accordance with a preferred embodiment of the present invention, providing includes pushing image content to a customer.

Still further, in accordance with a preferred embodiment of the present invention, the web session has image, video and/or advertising content therein.

### BRIEF DESCRIPTION OF TIME DRAWINGS

The subject matter regarded as the invention is particularly pointed out and distinctly claimed in the concluding portion of the specification. The invention, however, both as to organization and method of operation, together with objects, features, and advantages thereof may best be understood by reference to the following detailed description when read with the accompanying drawings in which:

FIG. 1 is a block diagram illustration of a synchronized voice and data system, constructed and operative in accordance with the present invention;

FIG. 2 is a schematic illustration of the association of web pages and IVR scripts, useful in the system of FIG. 1;

FIG. 3 is a block diagram illustration of a synchronizer and its operation, constructed and operative in accordance with the present invention;

FIG. 4 is a block diagram of an alternative embodiment of the synchronizer of FIG. 3, with a sales person;

FIG. 5 is a block diagram illustration of a further alternative embodiment of the synchronizer of FIG. 3;

FIG. 6 is a block diagram of a cellular telephone based embodiment of the synchronizer of FIG. 3; and

FIG. 7 is a block diagram of an alternative embodiment of the system of FIG. 6.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system registers and/or memories into other data similarly represented as physical quantities within the computing system memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer, or it may be a general purpose computer forming part of another device, such as a part of a personal digital assistant, a telephone or some such personal device. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Applicants have realized that voice communication is a powerful business tool, both for support purposes and for sales opportunities. But, other channels, most notably the web, also offer powerful tools for long-distance interaction. The present invention provides a tool that enhances communication by linking three critical channels, automated voice (traditional IVR) for high-volume communication, such as support desks, human voice for high-value communication, such as sales opportunities, and web browsing for visual and interactive display and collaboration.

Many companies have created web-based help desks and information centers. These often include thousands of pages of information, the ability to download useful documents, and sometimes even “live chat” with front line support staff. Even with all these advantages, these systems still fall short of IVR in several ways. For example, they often have no access to human voice assistance, the wide range of choices makes navigation often difficult and they are virtually unusable by visually-impaired customers.

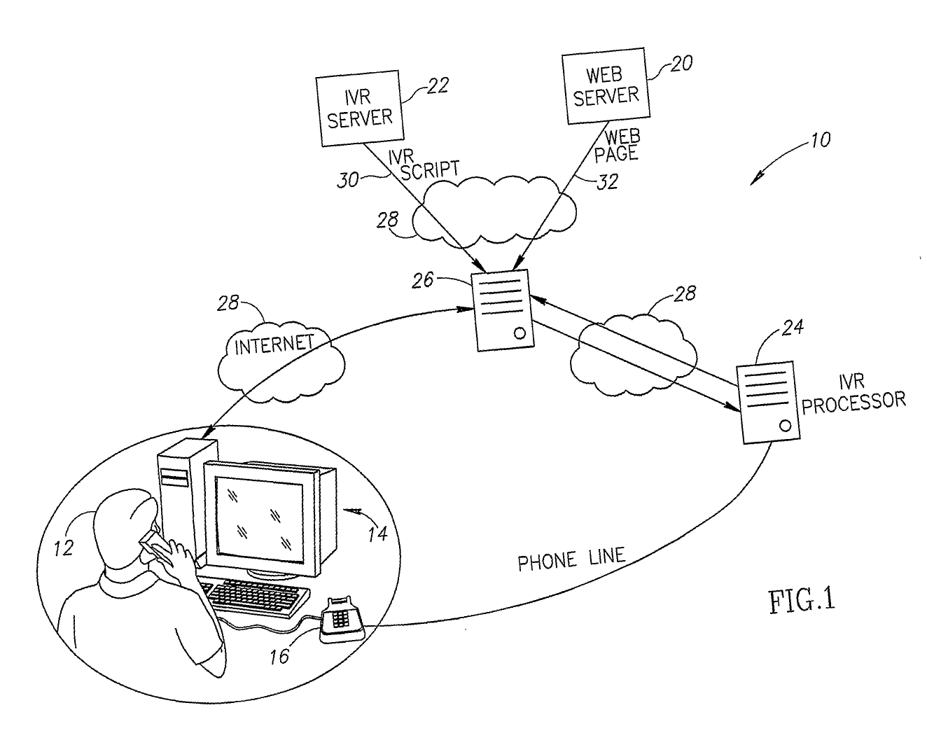

Reference is now made to FIG. 1, which details an innovative, synchronized voice and data system 10, constructed and operative in accordance with the present invention, which may provide long-distance communication with a user 12. In accordance with a preferred embodiment of the present invention, the communication may be through multiple channels, both a voice and a data channel. Thus, user 12 may work with a web browser 14 and a telephone 16. Web browser 14 may typically run a web browser, such as any of the common browsers (Microsoft Internet Explorer, Firefox, etc.) and telephone 16 may be any suitable telephone, such as a land-line phone, a mobile phone, a digital phone, or an analog phone.

System 10 may comprise a web server 20, an IVR script server 22, an IVR processor 24 and a server-based, multi-modal synchronizer 26. In some embodiments, any or all of elements 20, 22, 24 and 26 may be implemented as a single unit. System 10 may operate through a wide area network 28, such as the Internet, shown in FIG. 1 as three separate clouds.

Web server 20 may be any suitable web server, such as Apache or Microsoft IIS, which may provide web pages upon request. IVR server 22 may be any suitable IVR script server, such as Apache or Microsoft IIS, which may provide IVR scripts upon request. Synchronizer 26 may communicate with servers 20 and 22 and may provide their output to the relevant device, where web pages may be provided to web browser 14 and voice signals, generated by IVR processor 24 from IVR scripts provided by IVR server 22, may be provided to telephone 16.

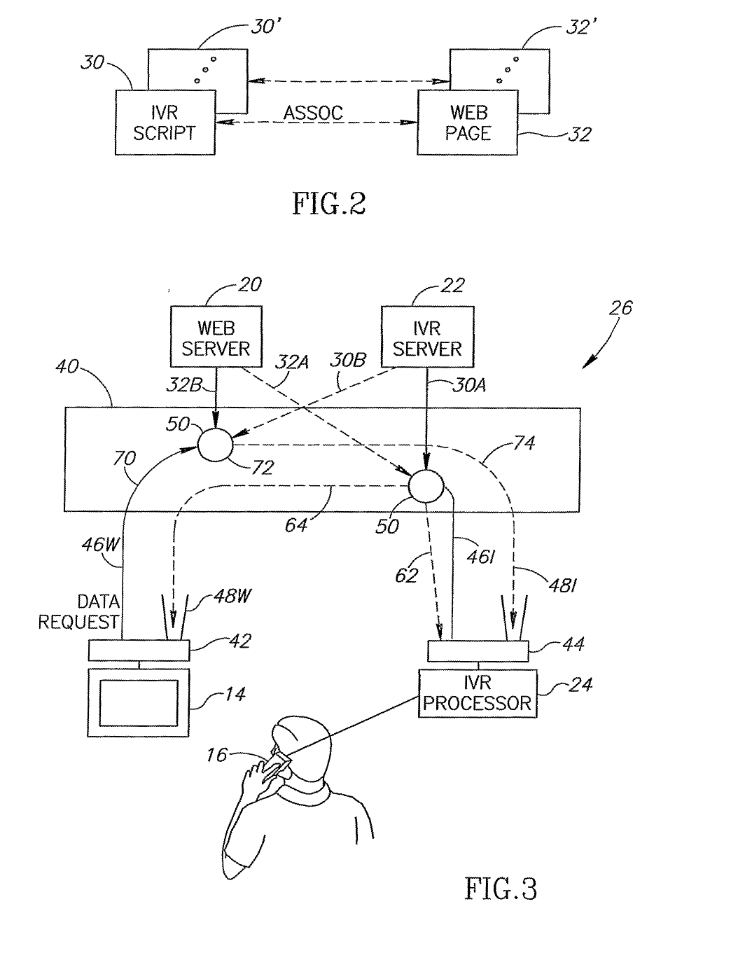

In accordance with a preferred embodiment of the present invention, user 12 may provide speech instructions to IVR server 22 via IVR processor 24 and IVR server 22 may provide an appropriate IVR script 30 in response. Synchronizer 26 may receive the selected IVR script 30 and may provide it to IVR processor 24 to generate speech for user 12. As shown in FIG. 2, to which reference is now briefly made, synchronizer 26 may have previously made associations between IVR scripts 30 and web pages 32, found in web server 20. These associations may be any appropriate type of association, such as one-to-one, one-to-many, many-to-one, or many-to-many. When synchronizer 26 may provide selected IVR script 30 to IVR processor 24, it may also request the associated web page 32 from web server 20 and may provide associated web page 32 to web browser 14. Web pages 32 may contain any type of content, such as video, images, data, audio, etc. that may be encoded in a web page or provided by a web server or similar server, typically in HTML or other web formats.

Similarly, user 12 may click on an item on web page 32. Web server 20 may process the resultant request and may provide a new web page 32′ (FIG. 2) in response. Synchronizer 26 may receive new web page 32′ and may provide it to web browser 14. In addition, synchronizer 26 may request the associated IVR script 30′ and may provide it to IVR processor 24 to generate the associated speech for telephone 16.

It will be appreciated that synchronizer 26 may synchronize the operations of IVR server 22 and web server 20, generating synchronized output to user 12 from both data sources. This may be a more effective mode of communication with user 12.

Synchronizer 26 may create a real-time synchronous link between an IVR or voice session running on any telephone, and a computer session running on any web browser. Synchronizer 26 may enable the following:

Any user action in the web browser may trigger a corresponding change in the IVR session.

Any user selection in the IVR session may trigger a change on the web browser, or the display of a new web page.

Synchronizer 26 may also work with live operators. The operator may be informed of any user action on the web browser. Alternatively, there may be multiple people interacting.

The operator may push content to the user's browser, including web pages, images, video, advertising or more. This may be used to present the user with catalog pages, forms to be signed, support documents, etc.

The client does not need any special equipment or software. Synchronizer 26 may work with any telephone and any standard web browser.

A major strength of the present invention is the fact that it is standards-compliant. Customers can use telephones of any kind (business PBX systems, regular home telephones, mobile phones, etc.) and any standard web browser (Internet Explorer, Firefox, etc).

The server can use CCXML and VoiceXML, SALT, or other standard call and voice management engines.

### Sample Applications

These examples present a number of ways in which synchronizer 26 enhances current telephone and web experiences. The first few examples focus on increasing customer satisfaction, while the last few illustrate uses of synchronizer 26 that create new sales channels and opportunities. It will be understood that the people, situations and companies described in the sample applications are all fictional.

### Site Map

In the first situation, Maria just bought a new VCR from QTech. For some reason, it seems to have come without an instruction manual. She'd like to receive a copy of the manual. More urgently, she wants to get the machine setup in time to record today's episode of her favorite soap opera, As the Stomach Churns. She calls the QTech support line, and hears “Press 1 for consumer products; press 2 for business customers; press 3 for customer support; press 4 for VCR products; press 5 for technical support.”

Martha can't figure out which number to press. Fortunately, the message continues “press 9 for web assistance.” She presses 9 and is instructed “browse to www.exampleqtech.com and type 2345 into the web assistance box.” She does so and is immediately shown a graphical site map of the QTech IVR menu. Martha is pleased to see that one option on the menu is “Easy guide to programming your VCR” and another is “order technical manuals.” She is amused to see that she would have had to type 4-2-3-1-7-1-4-5 to reach the first option and an even more convoluted sequence to Teach the second. But, thanks to synchronizer 26, Martha simply clicks the menu entries on her computer screen, and her telephone instantly takes her to each option.

When considering the above fictional situation, one of the most frustrating aspects of IVR interactions is that the customer always feels lost. Too many options are apparent, and many more are hidden, making it extremely difficult to navigate the system.

Vendors have no easy way to solve this problem. If they make each menu short and easy to use, than customers have to navigate through too many menus in order to reach anything useful. On the other hand, if they cram too much into each menu, then customers get lost in the verbiage.

In the present invention, a web interface offers a significant advantage. Large nested menus can be presented much more effectively on a two dimensional multi-color screen than they can be narrated by voice. But, the average customer also wants the key power of IVR systems: the capability of eventually reaching a useful voice response and even the final option of waiting on hold for a live attendant, but only when it is certain that no other option is appropriate.

System 10 offers the best of both worlds. It moves navigation to the web interface but leaves the final voice interactions on the telephone. It can even be used to create a single web page that combines all the menus from multiple loosely-coupled IVR systems. By increasing customer satisfaction and minimizing frustration, this system helps QTech retain its happy customers.

Many IVR sites are defined in VoiceXML, SALT, or some other similar language. The present invention may include an XML parsing tool that will read the entire site definition and automatically generate both a web site that portrays the menu in an attractive graphical format, as well as the “glue code” that will join and synchronize the IVR and web sessions.

### Sometimes You Need Voice

Susan does everything she can on the web. She is more comfortable on the computer than she is “wasting time” waiting for human operator to assist her. She greatly prefers a well-designed web interface to navigating “IVR hell.” Today, she went to Rocky Mountain Extreme's website to buy a lightweight sleeping bag, ropes, and carabiners for next week's jaunt up Mt. Rainier. To her dismay, the website doesn't give her enough information to determine which carabiner is the lightest one that will support her weight.

So, sighing in frustration, Susan enters her phone number into the site's Synchronizer 26 box and, a moment later, is called back by a service representative, Gary. Thanks to synchronizer 26, Gary immediately sees the contents of her shopping cart, and is able to pick up from where she left off on the website. As they're taking, Gary also persuades Susan to buy a bag of double-chocolate whole-grain energy bars. The sale is made mostly due to the attractive picture on the website, which Gary pushed to Susan's browser.

This situation shows that, no matter how much effort a vendor puts into creating the perfect website, sometimes the customer needs to speak to a live representative. A number of web site developers have already realized this and offer variants such as “live chat” or callback services. However, none of the current services can simultaneously work with regular telephones, push new content to the web browser, and monitor the customers browsing.

These combinations of features, offered by synchronizer 26, helped Gary improve Susan's shopping experience, as well as adding to the number of items she purchased.

### The Power of the Web

Daniel called his bank's IVR to check his account balance. To his surprise, he has $2,000 less than expected. The IVR does have an option to recite the last ten transactions, but Daniel has no patience to wait while the list is dictated back to him in that oh-so-annoying IVR voice. Even worse, he knows that he's just written a pile of small checks, and he's concerned that the problematic transaction is no longer one of the last ten.

Daniel would rather not call the bank branch; he figures that talking to a human will just add time and aggravation to his day. Besides, who knows how long he'll have to wait on hold.

The bank probably has a website too, but Daniel has never used it, and is not even sure if it needs the same PIN as the phone IVR, or may be a whole new password—one that he either never got or can't remember. Even though he's at his desk, right in front of his computer, this is also not an attractive option.

Fortunately, the bank has introduced synchronizer 26. The IVR prompt instructs Daniel to browse to www.exampleacmebank.com and type 293241 into the web assistance box. This key is time-lined and is supported by the security information Daniel has already supplied during the IVR session, allowing him to securely by pass the usual web login. Daniel can quickly and securely link his browser to his open IVR session without having to login again.

The IVR system is responsive to the new channel that has been opened and immediately changes its menu options, now offering “Press 3 to display the last 25 transactions on your computer.” Daniel quickly finds the answer to his question and finishes his banking activity in less than a minute.

This situation shows that, sometimes, it's not enough to simply map the IVR menu to a web page. A web page is a very different medium than a voice channel, and can display information in many different ways. A well-designed page can present information in ways that are simply not possibly in a linear voice presentation. In our example, Daniel was aided by the simple ability to present 25 transactions without having to listen to each one being read.

### Dinnertime Surprise

Sam has just finished eating dinner with his family when the phone rings. It's a salesman, trying to sell him a subscription to Modern Magnetics magazine. So, Sam asks a few questions and the salesman suggests that he go to ins computer, browse to www.examplemodmag.com, and type 2468 in the web box on-screen. Sam does so, and is brought immediately to a guided tour, driven by the salesman. As they chat, the images on the screen match the spiel and Sam is persuaded. As a matter of fact, he was so fascinated that he clicked the article “Magnetic spoons to reduce spillage of high-iron infant food.” The salesman sees that Sam has clicked this link and steers his spiel to stories about children. Sam is captivated. Not only does he order a five-year subscription for himself, he also gets one for his brother-in-law and another for his boss.

It's important to note that synchronizer 26 is much more powerful than a salesman simply telling his customer the address of a website. Because the two streams are synchronized, the salesman knows exactly what the customer is viewing, and can push new pages down to him at any time. And, crucially, this all works without having to install any software on the customer's computer!

### Bahamian Getaway

Joe and Susie are planing a vacation to the Bahamas. Joe calls Harry, at Acme Travel, to discuss the options. Harry invites him to try out Acme's new interactive website, powered by synchronizer 26. Joe browses to the site while the two of them continue to chat. After Joe is at the Acme website, Harry shows him pictures of various hotels and beaches and also directs related advertisements onto the webpage, guided by the flow of the conversation.

Joe and Susie not only have a great vacation, they also purchase new scuba gear and suitcases, motivated by the ads that appeared on the travel pages. Harry received a nice commission, both for booking the trip and for the related merchandise that he helped to sell.

And Acme Travel . . . well, for them it was a complete win. Not only did they gain a satisfied pair of customers; they paid nothing for system 10—it was completely financed by the ads that they showed on-site.

### Taken for a Ride

Doris returns to her hometown for her high school reunion and needs to rent a car to drive to the dance. She uses her new 3G mobile phone to call the only car rental agency in town to see what they have available, but is informed by the agency's IVR that no one is available to take her call. Fortunately, the agency had the foresight to implement a new interactive web-site using synchronizer 26 just in time for the reunion. Instead of being forced to listen to music while she waits, Doris is prompted to browse to www.examplecaragency.com and input a calling code. Without hanging up the call, Doris uses her phone's built-in browser to navigate to the site and input the code.

Doris is then shown a menu of available cars and rental plans which she can browse to her heart's content while waiting for a car rental agent to answer the phone. She sees videos of the agency's cars played on her phone's screen and receives detailed price quotes as well. When Oscar the agent finally answers the phone five minutes later, Doris has already narrowed her choice down to one of two cars, but she isn't sure which pricing plan she wants. Synchronizer 26 shows Oscar the cars and pricing plans that Doris has already seen so that he can close the deal without wasting her time telling her things she already knows. After Doris makes her decision, she enters her credit card information on her phone keypad instead of having to read out the digits over the phone. At the same time Oscar pushes a coupon image to Doris's browser which she can save and display for a discount at any store in town during reunion weekend.

### Synchronizer 26

Reference is now made to FIG. 3, which details one embodiment of synchronizer 26. Synchronizer 26 may comprise a state maintainer 40 for each combined session, typically identified by a session id. In some embodiments, synchronizer 26 may include means for interrupting the actions of one server 20 or 22 when the other server 22 or 20 may have some changed state.

The embodiment shown in FIG. 3 may be operative with servers 20 and 22 which typically use technologies such as HTML (for web server 20) and VoiceXML (for IVR server 22). Such technologies provide data only when requested and do not typically push unsolicited data to their clients.

In accordance with a preferred embodiment of the present invention, synchronizer 26 may additionally comprise a portion 42 of each web page 32 and a portion 44 of each IVR script 30.

Each of portions 42 and 44 may use an HTTP request, TCP connection, UDP connection, shared file or other channel, as is well known in the art, to open two channels of communication through state maintainer 40. The first channel may be a data request 46, which may request data from its respective server and, in the process, may change some aspect 50 of the combined session stored in state maintainer 40. The second channel may be an open channel 48, enabling an unsolicited web page 32 or IVR script 30 to be pushed from the relevant server 20 or 22 as a result of the changed session state. Open channels 48 may provide the synchronicity between the two servers 20 and 22.

Specifically, for an HTTP request, web page portion 42 may create its open channel, labeled 48W, by generating a “meta-refresh” instruction that may wait several minutes to perform the refresh. The trigger for the refresh may be the receipt of a new web page from state maintainer 40.

IVR script portion 44 may be written in the CCXML language and may comprise code to both start VoiceXML scripts and to poll for a next page, the latter being open channel 48X. The polling operation may be implemented through a “fetch” command. When a particular VoiceXML script may finish, it may pass control back to the CCXML script which may then load the next page, received from open channel 48X.

In operation, when user 12 provides speech instructions to IVR processor 24, IVR script portion 44 may generate its data request 46× and may open its open channel 48X. IVR data request 46X may change some item 50 of data within the state maintained by state maintainer 40. The change to item 50 may cause state maintainer 40 to request the appropriate IVR script, here labeled 32A, from IVR server 22 and its associated, unsolicited web page 30A from web server 20. State maintainer 40 may then provide (arrow 62) appropriate IVR script 32A back to IVR script portion 44 and may also provide (arrow 64) unsolicited web page 30A to web open channel 48W. IVR script portion 44 may then provide appropriate IVR script 32A to IVR processor 24 to generate voice signals to telephone 16. Web browser 14 may then display associated web page 30A, which includes its web portion 42.

A similar set of actions occur when user 12 may click on an item on web page 32. Web page portion 42 may generate its data request 46W and may open its open channel 48W. Web data request 46W may change some item 52 of data within the state maintained by state maintainer 40. The change to item 52 may cause state maintainer 40 to request the appropriate web page, here labeled 30B, from web server 20 and its associated, unsolicited IVR script 32B from IVR server 22. State maintainer 40 may then provide (arrow 72) appropriate web page 30B back to web page portion 42 and may also provide (arrow 74) unsolicited IVR script 32B to IVR open channel 48X. Web browser 14 may then display appropriate web page 30B. IVR script portion 44 may then provide associated IVR script 32B to IVR processor 24 to generate voice signals to telephone 16.

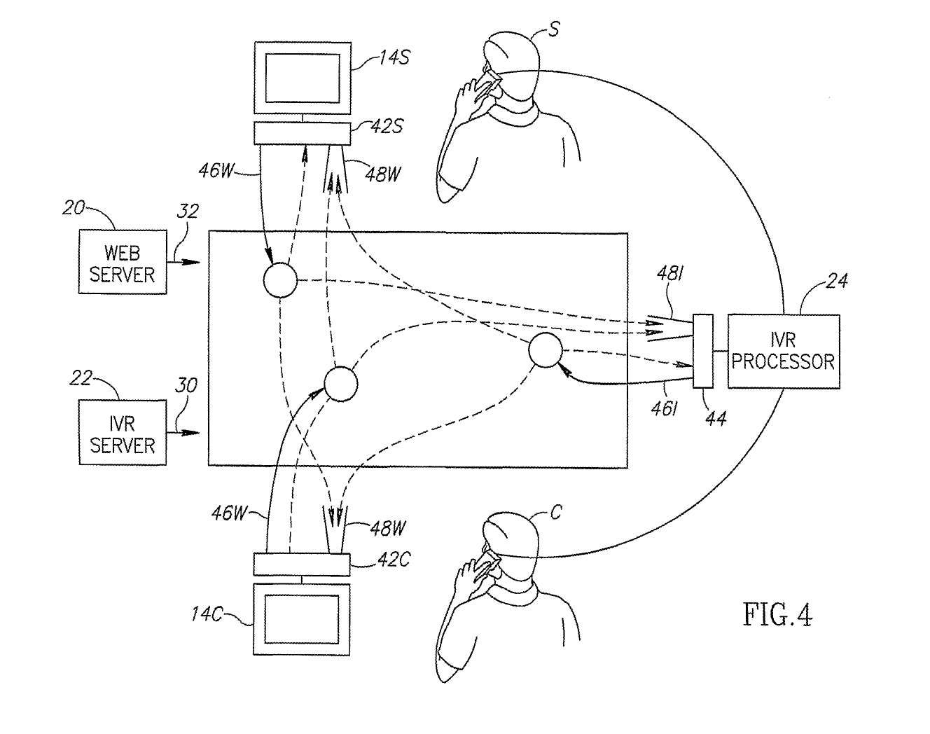

It will be appreciated that synchronizer 26 may keep the two modes of communication, voice and web, synchronized. Synchronizer 26 may also keep two people, for example, a sales person and a customer, synchronized as well, as can be seen in FIG. 4, to which reference is now made. FIG. 4 is similar to FIG. 3, and thus, similar reference numerals refer to similar items; however, FIG. 4 includes a sales person, S, in addition to the customer, here labeled C. Sales person S also has a telephone, 16S, and a web browser 14S. Similar items for customer C are labeled with a C. There is no additional IVR processor 24 as IVR processor 24 provides the same voice signals to both customer C and sales person S.

Synchronizer 26 operates as before, providing the requested IVR script 30 (with its IVR script portion 44) or web page 32 (with its web page portion 42) in response to the data request 46 that requested it. However, in this dual person embodiment, synchronizer 26 provides the associated IVR script 30 or web page 32 to all of the open channels 48 not associated with the data request 46 that requested the data.

It will be appreciated that synchronizer 26 may be expanded to enable multiple persons to communicate. IVR processor 24 may then operate in a “conference” mode and the web browser 14 for each person in the conference may run the web page portions 44 with each downloaded web page 32.

It will be appreciated that, in these multiple person embodiments, there may be some information that the parties wish to keep from each other. For example, sales person S may wish to review numerous web pages before deciding on which ones to show customer C. Customer C may be requested to enter private information, such as a password, which sales person S should not see. Thus, synchronizer 26 may also maintain “private state” for each person in the conversation and may require an indication in order to release any information to the other parties in the conversation. It will be appreciated that the data to be released may be of any suitable type, such as alphanumeric data and/or web pages and may include images, videos, audio, etc.

It will be appreciated that synchronizer 26 may provide a communication channel between IVR server 22 and web server 20. Moreover, synchronizer 26 may have a state maintainer 40 for each user's session. The servers may include session identification in each piece of data, or session update, passed through synchronizer 26, to identify to which session the piece of data belongs.

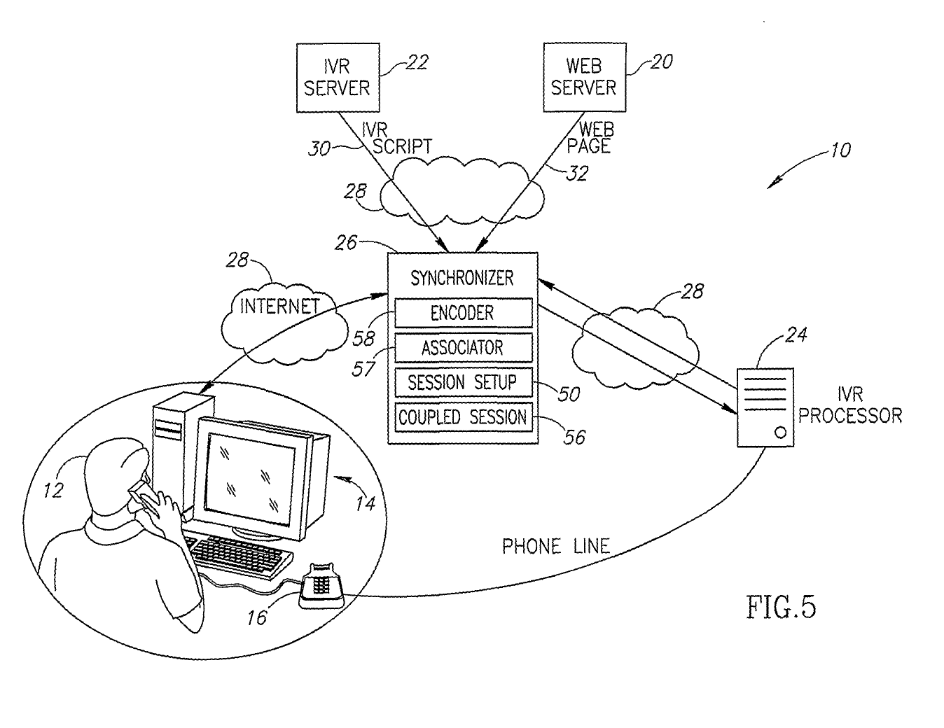

As shown in FIG. 5, synchronizer 26 may additionally comprise a unit 50 for enabling a coupled session 56, for defining a session identifier and for setting up state maintainer 40 for coupled session 56. Enabling unit 50 may initially make an IVR session 52 be aware of a web session 54. Once enabling unit 50 has coupled the two sessions, state maintainer 40 may synchronize them.

The process may begin when the user accesses one of servers 20 or 22. The accessed server 20 or 22 may begin a session, such as session A, generating a session identifier, for example, ID_A, for its local session and activating state maintainer 40 to create a new coupled session 56. The accessed server 20 or 22 may send the user to the other server 22 or 20 with an indication ID_A′ of session A and may store an association of local session identifier ID_A and indication ID_A′ in an associator 57, such as in a mapping table. The user may initiate a session B, with local identifier ID_B, on the other server 22 or 20 and may provide indication ID_A′ to it. Other server 22 or 20 may access associator 57 with indication ID_A′ to get other local identifier ID_A and may, if desired, provide session identifier ID_B to associator 57.

In some embodiments, telephone 16 may be a POTS (plain old telephone system) telephone and browser 14 may be a desktop browser. User 12 may initially call IVR server 22, which may open IVR session 52 with session identifier ID_A and may provide session identifier ID_A to associator 57.

IVR session 52 may read IVR script 30 which may give user 12 the URL of a web page 32 to be created especially for him. The URL may include indicator ID_A′ of session identifier ID_A. For example, the URL night be http://www.exampleacme.com/1234, where “1234” might be indicator ID_A′.

Session identifier ID_A may be of any length, such as of more than 10 digits. Synchronizer 26 may include an encoder 58, such as a hasher, to generate indication ID_A′ from session identifier ID_A but with a reduced number of digits. For example, indication ID_A′ may have 3-4 digits. Indications ID_A′ may have a limited lifetime, such as 5-10 minutes, so that they can be reused for other session identifiers.

It will be appreciated that indications ID_A′ may not be required. They may be utilized in situations where user 12 may be asked to enter information, as a form of identifier ID_A that a user may be more able to reliably remember. The following text may be described with indication ID_A′; it will be appreciated that identifier ID_A may be utilized in its stead.

User 12 may browse to the URL that IVR processor 24 announces to him on telephone 16. Web server 20 may receive the URL, may access associator 57 to determine the local identifier ID_A, which may serve as the coupled session id associated with indicator ID_A′, may generate an associated web session 54 and may associate its web session 54 with local identifier ID_A. Web server 20 may then generate the associated web page 32 for the current IVR script 30.

Whenever web server 20 may generate a new web request, such as when user 12 types something into the current web page 32, web server 20 may list other local identifier ID_A as part of the information in its request. Similarly, IVR server 22 may include local identifier ID_A, which acts also as the combined session identifier, in each IVR request.

In another embodiment, IVR server 22 may provide user 12 with a URL of a non-private website, such as http://www.exampleacme.com, and may tell user 12 to type indicator ID_A[0] in a page on that site. Web server 20 may receive the URL and may generate a web session 54 with an input box to prompt user 12 to enter indicator ID_A′.

Once user 12 may enter indicator ID_A′, web server 20 may access associator 57 for the coupled session id, such as ID_A, associated with indicator ID_A′ and may associate its web session 54, with session identifier ID_B, with coupled session id ID_A. Web server 20 may then generate the associated web page 32 for the current IVR script 30.

In another embodiment, user 12 may browse to a website, in response to which web server 20 may generate session identifier ID_B. Somewhere on the website may be a webpage capable of displaying a dedicated phone number for the user to dial. Synchronizer 26 may store a mapping between session identifier ID_B and the dedicated phone number.

Web server 20 may open a request for a session identifier from IVR server 22. When user 12 dials into IVR server 22, IVR server 22 may run a script to access the mapping, to ascertain session identifier ID_B. IVR server 22 may open a session, giving session identifier ID_A to it, and may provide session identifier ID_A and/or indicator ID_A′ to associator 57 and/or to web server 20.

Alternatively, the web page may list a non-specific phone number (i.e. the same phone number for all users), but may include a voice token, such as a number or a phrase to say, acting as indicator ID_A′, specific to the session. When user 12 dials in, IVR server 22 may open an IVR session with identifier ID_A. The initial IVR script 30 may include a prompt to say voice token ID_A′ supplied to him on the web page or may provide the user with a token to be typed into the webpage, which may act as indicator ID_A′.

In a still further embodiment, web page 32 may ask user 12 to enter his phone number. Web server 20 may then send this phone number, together with local session identifier ID_B, to IVR server 22. IVR server 22 may then open a session, with session identifier ID_A, and may call user 12 at the number. Once again, both session identifiers ID_A and ID_B may be fisted in mapping 57.

The present invention may operate with cellular telephones as well. Some cellular telephones have the ability to transfer data simultaneous with voice conversations, others do not. The present invention can synchronize both types of cellular telephones.

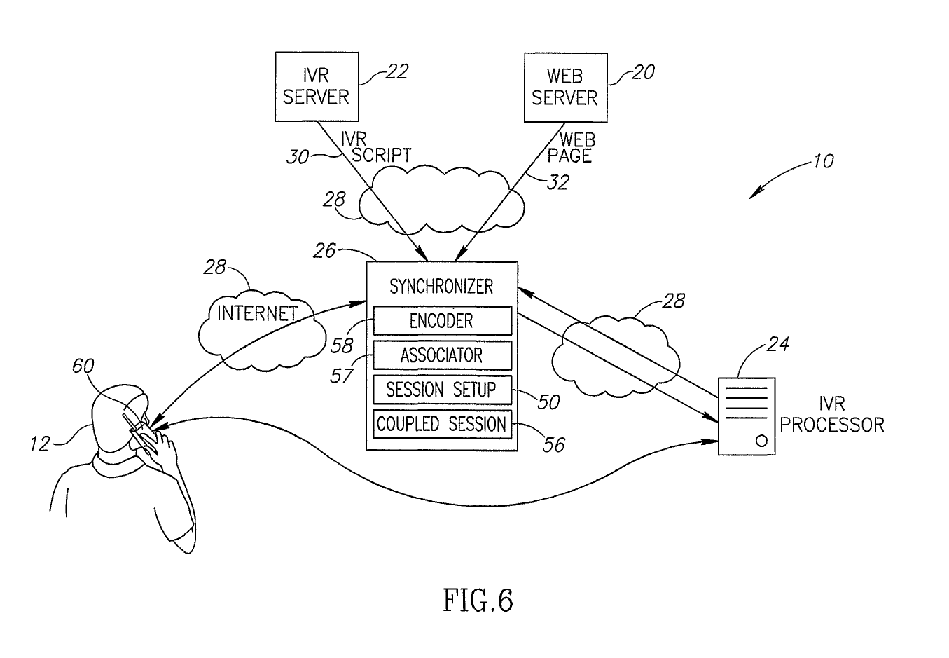

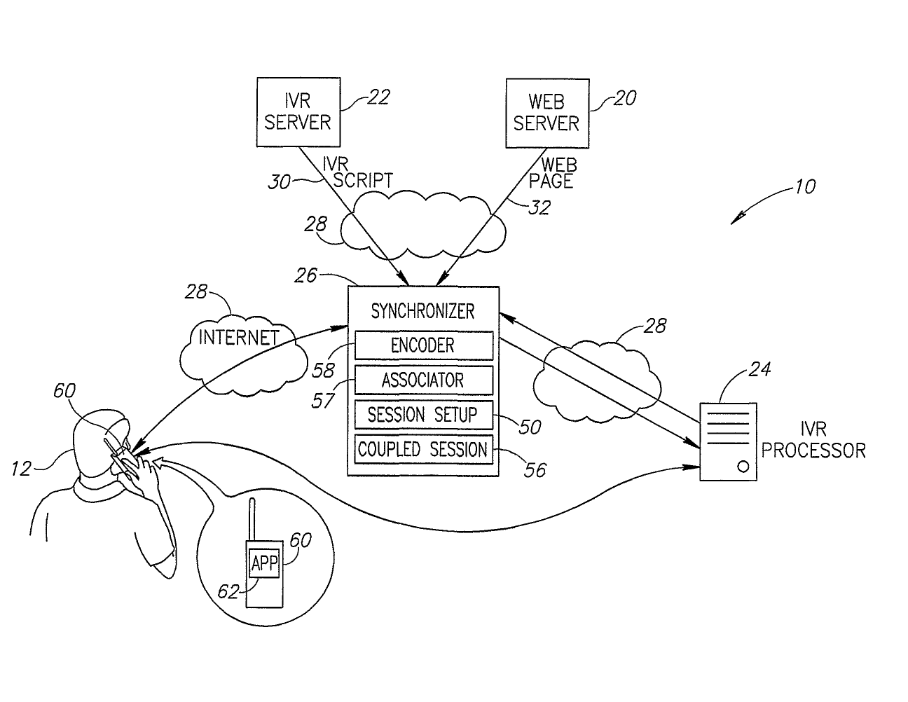

Applicants have realized that all recent cellular telephones have SMS (short message system) abilities and that the SMS system may be utilized to provide synchronization between IVR server 22 and web server 20. Such a system is illustrated in FIG. 6, to which reference is now made.

User 12 may have a cellular telephone 60 with SMS abilities. User 12 may dial IVR server 22 from his cellular telephone 16. IVR server 22 may receive the telephone number of cellular telephone 60, typically via its caller id (since most if not all cellular telephones have the caller id service turned on). IVR server 22 may open IVR session 52 with session identifier ID_A and may provide session identifier ID_A to associator 57. In addition, IVR script 30 may provide an SMS message to cellular telephone 60 with the data associated with current IVR script 30. For example, if IVR script 30 talks through a menu, SMS message may show the menu. IVR script 30 may send a new SMS message each time it wants to direct user 12.

It will be appreciated that, in this embodiment, web server 20 may not be accessed from the cellular telephone in this embodiment, since, in this embodiment, cellular telephone 16 may not have any simultaneous voice and data capabilities.

In another embodiment, cellular telephone 60 may have a web browser and may support simultaneous data and voice network channels, such as is available for 3G cellular telephones. As in the previous embodiment, user 12 may dial IVR server 22 from his cellular telephone 60 and IVR server 22 may receive the telephone number of telephone 60, typically via its caller id. IVR server 22 may open IVR session 52 with session identifier ID_A and may provide session identifier ID_A to associator 57. In this embodiment, IVR script 30 may provide an SMS message to cellular telephone 60 which lists a URL, such as the URL described hereinabove, with indicator ID_A′ as part of the URL. For example, the URL might be http://www.exampleacme.com/1234, where “1234” might be indicator ID_A′. The URL may be browsable (e.g. via WAP Push, embedded URL, etc.). After user 12 browses to the URL, the process may continue as described hereinabove for the first embodiment.

Alternatively, as shown in FIG. 7 to which reference is now briefly made, cellular telephone 60 may comprise a client application 62 of synchronizer 26 which may capture the SMS. Client 62 may interpret the SMS, may bring the browser of cellar telephone 60 to the foreground and may open the browser to the specified SMS. The remaining process may continue as described hereinabove for the previous embodiments.

It will be appreciated that the embodiment of FIG. 5 is operative for any type of telephone with a display and a browser of some kind. For example, it may be a cellular telephone, or it may be a desktop computer with a web browser and telephone capabilities (which may be a voice over IP phone or a connection to a regular telephone line), or it may be a personal digital assistant (PDA) with a telephone, etc.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1-39. (canceled)

40. A method comprising:
sending, from an IVR (interactive voice response), an activator for a web session to a mobile communication device engaged in a voice session with said IVR; and
once said web session is activated, synchronizing said web session and said voice session for said mobile communication device.

41. The method according to claim 40 and wherein said activator is an SMS (short message service) message.

42. The method according to claim 40 and wherein said activator includes a URL for said web session.

43. The method according to claim 42 and wherein said URL includes an indicator of said voice session.

44. A method comprising:
initiating a web session coupled to a voice session of a mobile communication device with an IVR server without input from the person who initiated said voice session; and
displaying said web session on said mobile communication device at least during a part of said voice session.

45. The method according to claim 44 and wherein said initiating comprises:
capturing an SMS from said IVR server to said mobile communication device;
interpreting a URL of a synchronizable website embedded in said SMS; and
bringing a web browser to the foreground opened to said URL.

46. The method according to claim 45 and wherein said initiating comprises said IVR server receiving a phone number of said mobile communication device via caller_id and sending said SMS to said phone number.

47. The method according to claim 44 and wherein said web session has advertising content therein.

48. The method according to claim 44 and also comprising triggering at least one action in said voice session in response to an action by a user in said web session.

49. The method according to claim 44 and also comprising triggering at least one action in said web session in response to an action by a user in said voice session.

50. The method according to claim 44 and wherein said mobile communication device is one of: a cellular telephone and a personal digital assistant.

51. A method implementable by an IVR (interactive voice response) server, the method comprising:
engaging in a voice session with a mobile communication device; and
sending SMS (short message service) messages to said mobile communication device with data relevant to said voice session.

52. The method according to claim 51 and also comprising, prior to said sending, receiving a telephone number of said mobile communication device from caller_id.
